(19) United States
(12) Patent Application Publication
(10) Pub. No.: US 2024/0047671 A1
(43) Pub. Date: Feb. 8, 2024

(54) POSITIVE ELECTRODE, AND RECHARGEABLE LITHIUM BATTERY INCLUDING THE SAME

(71) Applicant: SAMSUNG SDI CO., LTD., Yongin-si (KR)

(72) Inventors: Hyejin PARK, Yongin-si (KR); Yeji YANG, Yongin-si (KR); Wonseok CHO, Yongin-si (KR); Tae Jin LEE, Yongin-si (KR); Sangwoo PARK, Yongin-si (KR); Sundae KIM, Yongin-si (KR); Sanghyung KIM, Yongin-si (KR); Minseo KIM, Yongin-si (KR); Myungheui WOO, Yongin-si (KR); Sanghoon KIM, Yongin-si (KR); Hana RA, Yongin-si (KR); Bokyung RYU, Yongin-si (KR)

(21) Appl. No.: 18/303,343

(22) Filed: Apr. 19, 2023

(30) Foreign Application Priority Data
Jul. 27, 2022 (KR) 10-2022-0093413

(51) Int. Cl. H01M 4/525; H01M 10/052; H01M 4/62; H01M 4/583; H01M 4/38; H01M 4/36

(52) U.S. Cl. CPC H01M 4/525; H01M 10/052; H01M 4/624; H01M 4/583; H01M 4/386; H01M 4/366; H01M 2004/028

(57) ABSTRACT

A positive electrode includes a positive electrode active material, a binder, a conductive material, and an additive represented by Chemical Formula 1 or Chemical Formula 2:

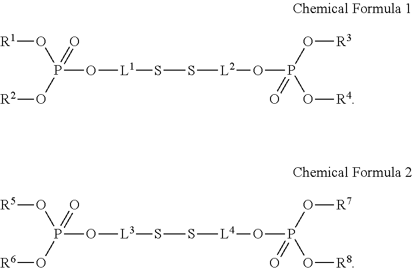

A rechargeable lithium battery includes the positive electrode a negative electrode in a negative electrode active material; and an electrolyte solution for the rechargeable lithium battery.

### CROSS-REFERENCE TO RELATED APPLICATION

This application claims priority to and the benefit of Korean Patent Application No. 10-2022-0093413, filed in the Korean Intellectual Property Office on Jul. 27, 2022, the entire content of which is incorporated herein by reference.

### BACKGROUND

### 1. Field

One or more aspects of embodiments of this disclosure relate to a positive electrode and a rechargeable lithium battery including the same.

### 2. Description of the Related Art

A rechargeable lithium battery may be recharged and has three or more times higher energy density per unit weight than a lead storage battery, nickel-cadmium battery, nickel hydrogen battery, nickel zinc battery and/or the like. The lithium battery may be also charged at a high rate and thus, may be commercially manufactured for a laptop, a cell phone, an electric tool, an electric bike, and/or the like, and research on improvement of additional energy density has been actively made.

In the rechargeable lithium battery, the positive electrode is fabricated by mixing a positive electrode active material, a binder, and a conductive agent in an organic solvent and dispersing the mixture to prepare positive electrode slurry composition, coating the positive electrode slurry composition on a positive electrode current collector, and then, drying and compressing the coated current collector.

In order to uniformly (or substantially uniformly) coat the positive electrode slurry composition on the current collector, the positive electrode active material, the binder, and the conductive agent should not be agglomerated with one another but should instead be uniformly (or substantially uniformly) dispersed in the organic solvent and have suitable viscosity stability over time. When the positive electrode slurry composition is not uniformly (or substantially uniformly) coated on the current collector, a uniform (or substantially uniformly) battery chemical reaction may not occur, and there may be problems such as electrode deformation due to an electrode thickness deviation and/or peeling of the active material during charging and discharging.

### SUMMARY

One or more aspects of embodiments of the present disclosure are directed toward a positive electrode having excellent high-temperature characteristics.

One or more aspects of embodiments of the present disclosure are directed toward a rechargeable lithium battery having improved storage characteristics at a high temperature by including the positive electrode.

Additional aspects will be set forth in part in the description which follows and, in part, will be apparent from the description, or may be learned by practice of the presented embodiments of the disclosure.

One or more embodiments of the present disclosure provide a positive electrode including a positive electrode active material, a binder, a conductive material, and an additive represented by Chemical Formula 1 or Chemical Formula 2:

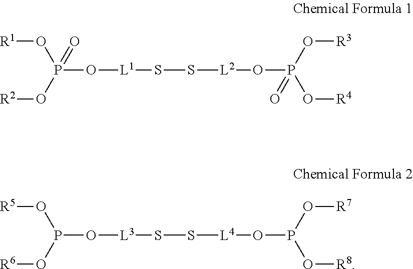

In Chemical Formula 1 and Chemical Formula 2,

R¹ to R⁸ may be each independently a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group,

R¹ to R⁸ may be each independently present, or

at least one pair selected from R¹ and R²; R³ and R⁴; R⁵ and R⁶; and R⁷ and R⁸ may be linked to each other to form a substituted or unsubstituted C2 to C30 monocyclic or C2 to C50 polycyclic aliphatic heterocycle, or a substituted or unsubstituted C2 to C30 monocyclic or C2 to C50 polycyclic aromatic heterocycle, and

L¹ to L⁴ may be each independently a substituted or unsubstituted C1 to C20 alkylene group.

Chemical Formula 1 may be represented by Chemical Formula 1A or Chemical Formula 1B:

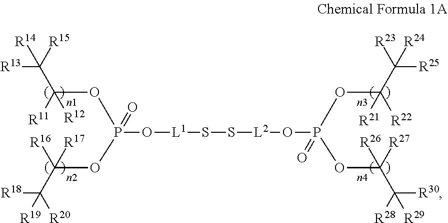

wherein, in Chemical Formula 1A,

R¹¹ to R³⁰ may be each independently hydrogen, a halogen, or a substituted or unsubstituted C1 to C10 alkyl group,

n1 to n4 may be each independently an integer of 0 to 4, and

L¹ and L² may be each independently a substituted or unsubstituted C1 to C20 alkylene group;

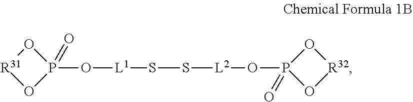

wherein, in Chemical Formula 1B,

R³¹ and R³² may be each independently a substituted or unsubstituted C2 to C10 alkylene group, and

L¹ and L² may be each independently a substituted or unsubstituted C1 to C20 alkylene group.

Chemical Formula 1B may be represented by Chemical Formula 1B-I or Chemical Formula 1B-II.

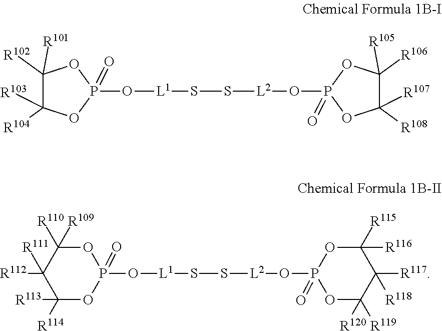

In Chemical Formula 1B-I and Chemical Formula 1B-II,

R¹⁰¹ to R¹²⁰ may be each independently hydrogen, a halogen, or a substituted or unsubstituted C1 to C10 alkyl group, and

L¹ and L² may be each independently a substituted or unsubstituted C1 to C20 alkylene group.

Chemical Formula 2 may be represented by Chemical Formula 2A or Chemical Formula 2B:

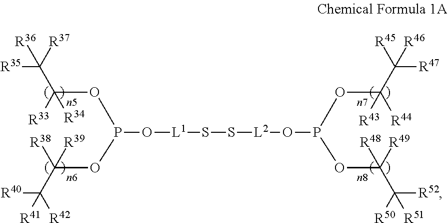

In Chemical Formula 2A,

R³³ to R⁵² may be each independently hydrogen, a halogen, or a substituted or unsubstituted C1 to C10 alkyl group,

n5 to n8 may be each independently an integer of 0 to 4, and

L³ and L⁴ may be each independently a substituted or unsubstituted C1 to C20 alkylene group;

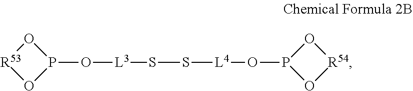

wherein, in Chemical Formula 2B,

R⁵³ and R⁵⁴ may be each independently a substituted or unsubstituted C2 to C10 alkylene group, and

L³ and L⁴ may be each independently a substituted or unsubstituted C1 to C20 alkylene group.

Chemical Formula 2B may be represented by Chemical Formula 2B-I or Chemical Formula 2B-II:

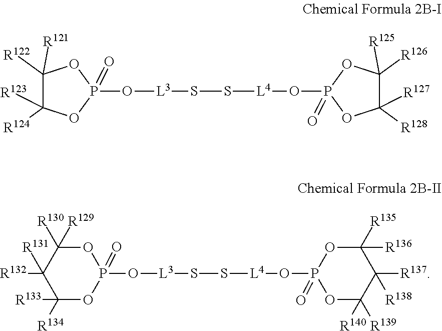

In Chemical Formula 2B-I and Chemical Formula 2B-II,

R¹²¹ to R¹⁴⁰ may be each independently hydrogen, a halogen, or a substituted or unsubstituted C1 to C10 alkyl group, and

L³ and L⁴ may be each independently a substituted or unsubstituted C1 to C20 alkylene group.

Chemical Formula 1 may be represented by Chemical Formula 1B-I-1 or Chemical Formula 2B-I-1.

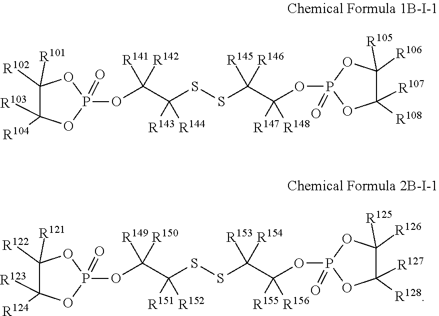

In Chemical Formula 1B-I-1 and Chemical Formula 2B-I-1,

R¹⁰¹ to R¹⁰⁸, R¹²¹ to R¹²⁸, and R¹⁴¹ to R¹⁵⁶ may be each independently hydrogen, a halogen, or a substituted or unsubstituted C1 to C10 alkyl group.

The additive may be included in an amount of about 0.001 to 0.05 parts by weight based on 100 parts by weight of the positive electrode active material, the binder, and the conductive material.

The additive may be included in an amount of about 0.005 to 0.05 parts by weight based on 100 parts by weight of the positive electrode active material, the binder, and the conductive material.

The positive electrode active material may be represented by Chemical Formula 4:

LiₓM¹_{y}M²_{z}M³_{1-y-z}O_{2±a}X_{b}. Chemical Formula 4

In Chemical Formula 4,

0.5≤x≤1.8, 0≤a≤0.1, 0≤y≤1, 0<y+z≤1, M¹, M², and M³ may be each independently one or more elements selected from Ni, Co, Mn, Al, B, Ba, Ca, Ce, Cr, Fe, Mo, Nb, Si, Sr, Mg, Ti, V, W, Zr, La, and a combination thereof, and X may be one or more elements selected from F, S, P, and Cl.

In Chemical Formula 4, 0.8≤y≤1, 0≤z≤0.2, and M¹ may be Ni.

One or more embodiments of the present disclosure provide a rechargeable lithium battery including the aforementioned positive electrode; a negative electrode including a negative electrode active material; and an electrolyte solution for a rechargeable lithium battery.

A positive electrode film may be further included on the surface of the positive electrode, and the positive electrode film may be formed by coordinating the additive represented by Chemical Formula 1 or Chemical Formula 2 to the positive electrode active material.

The negative electrode active material may include at least one selected from graphite and Si composite.

The Si composite may include a core including Si-based particles and an amorphous carbon coating layer.

The Si-based particles may include at least one selected from Si particles, a Si—C composite, SiOₓ (0<x≤2), and a Si alloy.

It may be possible to implement a rechargeable lithium battery with improved high-temperature characteristics by suppressing or reducing the collapse of the positive electrode active material and thus suppressing or reducing an increase in the resistance of the battery during high-temperature storage and/or reducing the amount of gas generated.

In addition, by using the additive of the present embodiments in the positive electrode, problems due to electrochemical reactions that may occur when the additive is used in an electrolyte solution may be prevented or reduced.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view illustrating a rechargeable lithium battery according to one or more embodiments of the present disclosure.

FIG. 2 is a graph showing the amount of heat flow according to temperature measured by differential scanning calorimetry (DSC) for the positive electrodes according to Examples 1 to 3 and Comparative Example 1.

FIGS. 3 and 4 show XPS analysis results of the positive electrode of the rechargeable lithium battery cells prepared according to Example 1 and Comparative Example 1.

FIG. 5 is a graph showing the results of negative electrode cyclic voltammetry (CV) at room temperature of the electrolyte solutions according to Comparative Examples 1 and 4.

### DETAILED DESCRIPTION

Hereinafter, embodiments of the present disclosure are described in more detail. However, the embodiments are presented as an example, and the present disclosure is not limited thereto, and the present disclosure is only defined by the scope of the following claims and their equivalents.

It will be understood that, although the terms first, second, etc. may be used herein to describe various elements, these elements should not be limited by these terms. These terms are only used to distinguish one element from another element. Thus, a first element could be termed a second element without departing from the teachings of the present invention. Similarly, a second element could be termed a first element. As used herein, the singular forms are intended to include the plural forms as well, unless the context clearly indicates otherwise.

As used herein, the singular forms “a,” “an,” and “the” are intended to include the plural forms as well, unless the context clearly indicates otherwise.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items. Further, the use of “may” when describing embodiments of the present disclosure refers to “one or more embodiments of the present disclosure”.

It will be understood that when an element is referred to as being “on,” “connected to,” or “coupled to” another element, it may be directly on, connected, or coupled to the other element or one or more intervening elements may also be present. When an element is referred to as being “directly on,” “directly connected to,” or “directly coupled to” another element, there are no intervening elements present.

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The electronic device and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

In the present specification, when a definition is not otherwise provided, “substituted” refers to replacement of at least one hydrogen of a substituent or a compound by deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C2 to C30 alkenyl group, a C3 to C30 cycloalkyl group, a C3 to C30 cycloalkenyl group, a C2 to C30 alkynyl group, a C3 to C30 cycloalkynyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

For example, “substituted” may refer to replacement of at least one hydrogen of a substituent or a compound by deuterium, a halogen, a C1 to C30 alkyl group, a C2 to C10 alkenyl group, a C3 to C10 cycloalkyl group, a C3 to C10 cycloalkenyl group, a C2 to C10 alkynyl group, a C3 to C10 cycloalkynyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In some embodiments, “substituted” may refer to replacement of at least one hydrogen of a substituent or a compound by deuterium, a halogen, a C1 to C20 alkyl group, a C6 to C30 aryl group, a C1 to C10 fluoroalkyl group, or a cyano group. For example, “substituted” may refer to replacement of at least one hydrogen of a substituent or a compound by deuterium, a halogen, a C1 to C5 alkyl group, a C6 to C18 aryl group, a C1 to C5 fluoroalkyl group, or a cyano group. For example, “substituted” may refer to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

A positive electrode according to one or more embodiments includes a positive electrode active material, a binder, a conductive material, and an additive represented by Chemical Formula 1 or Chemical Formula 2:

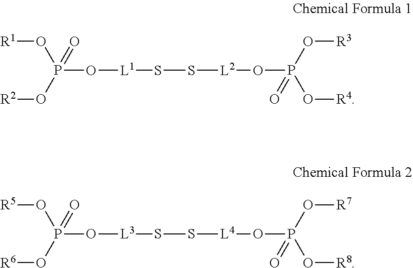

In Chemical Formula 1 and Chemical Formula 2,

R¹ to R⁸ may be each independently a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group,

R¹ to R⁸ may be each independently present, or

at least one selected from R¹ and R²; R³ and R⁴; R⁵ and R⁶; and R⁷ and R⁸ may be linked to form a substituted or unsubstituted C2 to C30 monocyclic or C2 to C50 polycyclic aliphatic heterocycle, or a substituted or unsubstituted C2 to C30 monocyclic or C2 to C50 polycyclic aromatic heterocycle, and

L¹ to L⁴ may be each independently a substituted or unsubstituted C1 to C20 alkylene group.

The additive may be coordinated with the positive electrode active material and thus may form a film on the surface of the positive electrode and suppress or reduce collapse of the positive electrode active material.

The film on the surface of the positive electrode may be formed by coordination of the additive represented by Chemical Formula 1 or 2 with the positive electrode active material.

For example, the film may be to form a complex compound by a lone pair of electrons of disulfide of the additive with a metal of the positive electrode active material.

In some embodiments, when directly applied to the positive electrode, the additive may prevent or reduce the occurrence of an electrochemical reaction when the additive is applied to an electrolyte solution, and thus may prevent or reduce discoloring of the electrolyte solution. By way of comparison, when the additive is applied to the electrolyte solution, the additive is first decomposed by reduction on the surface of the negative electrode before forming a complex compound at the positive electrode and resultantly, may reduce an amount of the complex compound produced at the positive electrode. However, when the additive is applied to the positive electrode, the amount of the complex compound with the positive electrode active material may be much (e.g., significantly) increased.

In one or more embodiments, when the additive is applied to the positive electrode, the surface protection effect of the positive electrode may be much (e.g., significantly) improved.

In some embodiments, the additive is a bisphosphate-based or bisphosphite-based compound, and may have a structure linked by a disulfide linker.

The bisphosphate-based and bisphosphite-based compounds may be decomposed into two phosphate-based compounds or two phosphite-based compounds based on the disulfide linker.

These compounds may form a film on the respective surfaces of the positive and negative electrodes and thus suppress or reduce a resistance increase on the films during the high-temperature storage and increase film stability, thus improving high temperature cycle-life and thermal safety characteristics.

For example, the additive may be represented by Chemical Formula 1A or Chemical Formula 1B:

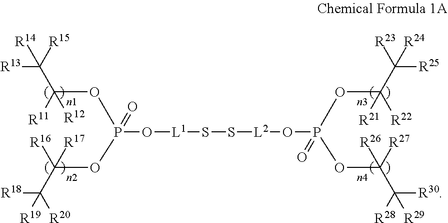

In Chemical Formula 1A,

R¹¹ to R³⁰ may be each independently hydrogen, a halogen, or a substituted or unsubstituted C1 to C10 alkyl group,

n1 to n4 may be each independently an integer of 0 to 4, and

L¹ and L² may be each independently a substituted or unsubstituted C1 to C20 alkylene group;

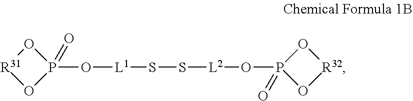

wherein, in Chemical Formula 1B,

R³¹ and R³² may be each independently a substituted or unsubstituted C2 to C10 alkylene group, and

L¹ and L² may be each independently a substituted or unsubstituted C1 to C20 alkylene group.

In one or more embodiments, R¹¹ to R³⁰ may each independently be hydrogen, a halogen, or a substituted or unsubstituted C1 to C5 alkyl group, n1 to n4 may each independently be one of an integer of 0 to 3, and L¹ and L² may each independently be a substituted or unsubstituted C2 to C20 alkylene group.

In one or more embodiments, R¹¹ to R³⁰ may each independently be hydrogen, a halogen, or a substituted or unsubstituted C1 to C3 alkyl group, n1 to n4 are each independently an integer of 0 to 2, and L¹ and L² may each independently be a substituted or unsubstituted C2 to C10 alkylene group.

In one or more embodiments, R³¹ and R³² may each independently be a substituted or unsubstituted C2 to C5 alkylene group, and L¹ and L² may each independently be a substituted or unsubstituted C2 to C20 alkylene group.

In one or more embodiments, R³¹ and R³² may each independently be a substituted or unsubstituted C2 to C4 alkylene group, and L¹ and L² may each independently be a substituted or unsubstituted C2 to C10 alkylene group.

For example, Chemical Formula 1B may be represented by Chemical Formula 1B-I or Chemical Formula 1B-II:

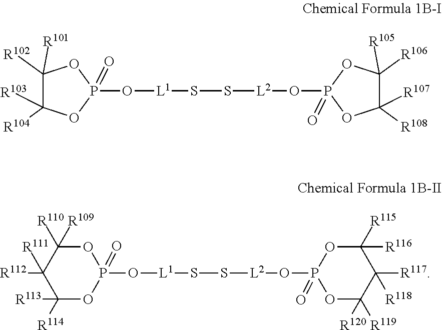

In Chemical Formula 1B-I and Chemical Formula 1B-II,

R¹⁰¹ to R¹²⁰ may be each independently hydrogen, a halogen, or a substituted or unsubstituted C1 to C10 alkyl group, and

L¹ and L² are the same as described above.

In one or more embodiments, R¹⁰¹ to R¹²⁰ may each independently be hydrogen, a halogen, or a substituted or unsubstituted C1 to C5 alkyl group.

In one or more embodiments, each of R¹⁰¹ to R¹²⁰ may be hydrogen.

In one or more embodiments, the additive may be represented by Chemical Formula 2A or Chemical Formula 2B:

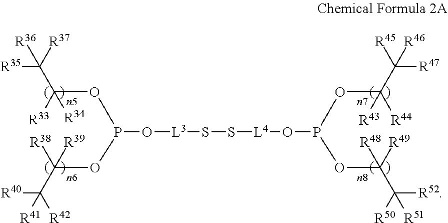

In Chemical Formula 2A,

R³³ to R⁵² may be each independently hydrogen, a halogen, or a substituted or unsubstituted C1 to C10 alkyl group,

n5 to n8 may be each independently an integer of 0 to 4, and

L³ and L⁴ may be each independently a substituted or unsubstituted C1 to C20 alkylene group;

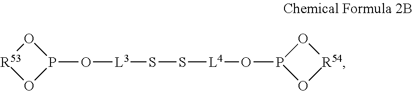

wherein, in Chemical Formula 2B,

R⁵³ and R⁵⁴ may be each independently a substituted or unsubstituted C2 to C10 alkylene group, and

L³ and L⁴ may be each independently a substituted or unsubstituted C1 to C20 alkylene group.

In one or more embodiments, R³³ to R⁵² may each independently be hydrogen, a halogen or a substituted or unsubstituted C1 to C5 alkyl group, n5 to n8 may each independently be an integer of 0 to 3, and L³ and L⁴ may each independently be a substituted or unsubstituted C2 to C20 alkylene group.

In one or more embodiments, R³³ to R⁵² may each independently be hydrogen, a halogen, or a substituted or unsubstituted C1 to C3 alkyl group, n5 to n8 may each independently be an integer of 0 to 2, and L³ and L⁴ may each independently be a substituted or unsubstituted C2 to C10 alkylene group.

For example, R⁵³ and R⁵⁴ may each independently be a substituted or unsubstituted C2 to C5 alkylene group, and L³ and L⁴ may each independently be a substituted or unsubstituted C2 to C20 alkylene group.

In some embodiments, R⁵³ and R⁵⁴ may each independently be a substituted or unsubstituted C2 to C4 alkylene group, and L³ and L⁴ may each independently be a substituted or unsubstituted C2 to C10 alkylene group.

For example, Chemical Formula 2B may be represented by Chemical Formula 2B-I or Chemical Formula 2B-II:

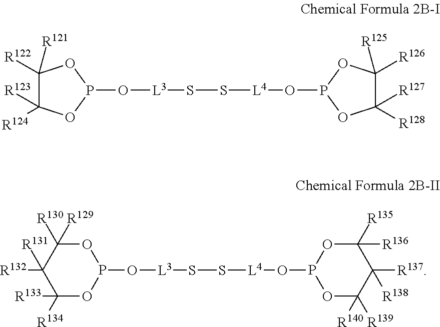

In Chemical Formula 2B-I and Chemical Formula 2B-II,

R¹²¹ to R¹⁴⁰ may be each independently hydrogen, a halogen, or a substituted or unsubstituted C1 to C10 alkyl group, and

L³ and L⁴ are the same as described above.

in one or more embodiments, R¹²¹ to R¹⁴⁰ may each independently be hydrogen, a halogen or a substituted or unsubstituted C1 to C5 alkyl group.

In one or more embodiments, R¹²¹ to R¹⁴⁰ may each be hydrogen.

The additive according to one or more embodiments of the present disclosure may be represented by Chemical Formula 1B-I-1 or Chemical Formula 2B-I-1:

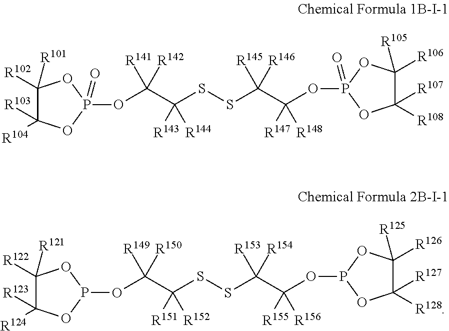

In Chemical Formula 1B-I-1 and Chemical Formula 2B-I-1,

R¹⁰¹ to R¹⁰⁸, R¹²¹ to R¹²⁸, and R¹⁴¹ to R¹⁵⁶ may be each independently hydrogen, a halogen, or a substituted or unsubstituted C1 to C10 alkyl group,

L³ and L⁴ are the same as described above.

In one or more embodiments, R¹⁰¹ to R¹⁰⁸, R¹²¹ to R¹²⁸, and R¹⁴¹ to R¹⁵⁶ may each independently be hydrogen, a halogen, or a substituted or unsubstituted C1 to C5 alkyl group.

In some embodiments, R¹⁰¹ to R¹⁰⁸, R¹²¹ to R¹²⁸, and R¹⁴¹ to R¹⁵⁶ may each be hydrogen.

The additive may be included in an amount of about 0.001 to 0.05 parts by weight based on 100 parts by weight of the positive electrode active material, the binder, and the conductive material.

For example, the additive may be included in an amount of about 0.005 to 0.05 parts by weight based on 100 parts by weight of the positive electrode active material, the binder, and the conductive material.

The additive may improve storage characteristics at a high temperature by combining with the positive electrode active material to form a film on the surface of the positive electrode, and when added in the above content range, a degree of improvement in the amount of gas generated may be significantly exhibited without increasing resistance.

The positive electrode active material may include lithiated intercalation compounds that reversibly intercalate and deintercalate lithium ions.

For example, the positive electrode active material may include at least one of composite oxides of lithium and a metal selected from cobalt, manganese, nickel, iron, and a combination thereof.

However, embodiments of the present disclosure are not limited thereto and in some embodiments, a portion of the metal of the composite oxide may be substituted with another suitable metal. In some embodiments, the phosphoric acid compound of the composite oxide, for example, may be at least one selected from LiNiPO₄, LiFePO₄, LiCoPO₄, and LiMnPO₄, and composite oxide having a coating layer on the surface thereof or a mixture of the composite oxide and the composite oxide having a coating layer may be used. The coating layer may include at least one coating element compound selected from an oxide of a coating element, a hydroxide of a coating element, an oxyhydroxide of a coating element, an oxycarbonate of a coating element, and a hydroxycarbonate of a coating element. The compound for the coating layer may be amorphous or crystalline. As the coating element included in the coating layer, Mg, Al, Co, K, Na, Ca, Si, Ti, V, Sn, Ge, Ga, B, As, Zr, or a mixture thereof may be used. The coating layer may be disposed (e.g., coated) in a method having no (or substantially no) adverse influence on properties of a positive electrode active material by using these elements in the compound. For example, the method may include any suitable coating method such as spray coating, dipping, and/or the like, but is not illustrated in more detail since it is well-known to those who work in the related field.

The positive electrode active material may be, for example, at least one of lithium composite oxides represented by Chemical Formula 4:

LiₓM¹_{y}M²ₓM³_{1-y-z}O_{2±a}X_{b}. Chemical Formula 4

In Chemical Formula 4,

0.5≤x≤1.8, 0≤a≤0.1, 0≤y≤1, 0<y≤1, 0≤z≤1, 0<y+z≤1, M¹, M², and M³ may be each independently one or more elements selected from Ni, Co, Mn, Al, B, Ba, Ca, Ce, Cr, Fe, Mo, Nb, Si, Sr, Mg, Ti, V, W, Zr, La, and a combination thereof, and X may be one or more elements selected from F, S, P, and Cl.

in one or more embodiments the positive electrode active material may be at least one selected from LiCoO₂, LiNiO₂, LiMnO₂, LiMn₂O₄, LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1).

In Formula 4, 0.8≤y≤1, 0≤z≤0.2, and M¹ may be Ni.

For example, the positive electrode active material selected from LiNi_{b}Mn_{c}Co_{d}O₂ (b+c+d=1), LiNi_{b}Mn_{c}Co_{d}AlₑO₂ (b+c+d+e=1), and LiNi_{b}Co_{d}AlₑO₂ (b+d+e=1) may be a high Ni-based positive electrode active material.

For example, in the case of the LiNi_{b}Mn_{c}Co_{d}O₂ (b+c+d=1) and LiNi_{b}Mn_{c}Co_{d}AlₑO₂ (b+c+d+e=1), the nickel content may be greater than or equal to about 60% (b≥0.6), and for example, greater than or equal to about 80% (b≥0.8).

For example, in the case of LiNi_{b}Co_{d}AlₑO₂ (b+d+e=1), the nickel content may be greater than or equal to about 60% (b≥0.6), and for example, greater than or equal to about 80% (b≥0.8).

A content of the positive electrode active material may be about 90 wt % to about 98 wt % based on the total weight of the positive electrode composition.

A content of the conductive material and the binder may be about 1 wt % to about 5 wt % based on the total weight of the positive electrode composition, respectively.

The conductive material is included to impart conductivity to the positive electrode, and any suitable electrically conductive material may be used as a conductive material unless it causes a chemical change in a battery. Examples of the conductive material may include a carbon-based material such as natural graphite, artificial graphite, carbon black, acetylene black, ketjen black, carbon fiber, and/or the like; a metal-based material of a metal powder and/or a metal fiber including copper, nickel, aluminum, silver, and/or the like; a conductive polymer such as a polyphenylene derivative; or a mixture thereof.

The binder improves binding properties of positive electrode active material particles with one another and with a current collector. Examples thereof may be (e.g., may include) polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

One or more embodiments provide a rechargeable lithium battery including the positive electrode according to the present embodiments; a negative electrode including a negative electrode active material; and an electrolyte solution for a rechargeable lithium battery.

The positive electrode includes a positive electrode current collector and a positive electrode active material layer on the positive electrode current collector, and the positive electrode active material layer includes the positive electrode active material.

The positive electrode current collector may include Al, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material capable of doping/dedoping lithium, and/or transition metal oxide.

The material that reversibly intercalates/deintercalates lithium ions may include a carbon material. The carbon material may be any suitable carbon-based negative electrode active material in a rechargeable lithium battery. Examples thereof may be (e.g., may include) crystalline carbon, amorphous carbon, and/or a mixture thereof. The crystalline carbon may be non-shaped (e.g., may have an abstract shape), and/or may be sheet, flake, spherical, and/or fiber-shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, a Si-C composite, SiOₓ (0<x<2), a Si-Q alloy (wherein Q is an element selected from an alkali metal, an alkaline-earth metal, a Group 13 element, a Group 14 element except for Si, a Group 15 element, a Group 16 element, a transition metal, a rare earth element, and a combination thereof), Sn, SnO₂, and/or Sn—R¹¹ (wherein R¹¹ is an element selected from an alkali metal, an alkaline-earth metal, a Group 13 element, a Group 14 element except for Sn, a Group 15 element, a Group 16 element, a transition metal, a rare earth element, and a combination thereof). At least one of these materials may be mixed with SiO₂.

The elements Q and R¹¹ may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be vanadium oxide, lithium vanadium oxide, or lithium titanium oxide.

In one or more embodiments, the negative electrode active material may include at least one selected from graphite and a Si composite.

The Si composite may include a core including Si-based particles and an amorphous carbon coating layer, and for example, the Si-based particles may include at least one selected from Si particles, a Si—C composite, SiOₓ (0<x≤2), and a Si alloy.

The central portion of the core including Si-based particles may include voids, and a radius of the central portion may correspond to about 30% to about 50% of the radius of the Si composite, an average particle diameter of the Si composite may be about 5 μm to 20 μm, and an average particle diameter of the Si-based particles may be about 10 nm to about 200 nm.

In the present disclosure, an average particle diameter may be particle size (D50) at a volume ratio of 50% in a cumulative size-distribution curve. For example, the average particle diameter may be, for example, a median diameter (D50) measured utilizing a laser diffraction particle diameter distribution meter. Also, in the present specification, when particles are spherical, “diameter” indicates a particle diameter, and when the particles are non-spherical, the “diameter” indicates a major axis length.

When the Si-based particles have an average particle diameter within the range, volume expansion during the charge and discharge may be suppressed or reduced, and interruption of a conductive path due to particle crushing during the charge and discharge may be prevented or reduced.

The core including the Si-based particles further includes amorphous carbon, and in this case, the central portion does not include (e.g., may exclude) amorphous carbon, and the amorphous carbon may present only on (and/or in) the surface portion of the Si composite.

Herein, the surface portion refers to a region from the outermost peripheral surface of the center portion to the outermost peripheral surface of the Si composite.

In one or more embodiments, the Si-based particles are substantially uniformly included in the Si composite as whole, for example, the Si-based particles may be present in a substantially uniform concentration in the central portion and the surface portion of the Si composite.

The amorphous carbon may be soft carbon, hard carbon, mesophase pitch carbonized product, calcined coke, or a combination thereof.

The amorphous carbon precursor may include a coal-based pitch, mesophase pitch, petroleum-based pitch, coal-based oil, petroleum-based heavy oil, and/or a polymer resin such as a phenol resin, a furan resin, and/or a polyimide resin.

For example, the Si—C composite may include Si particles and crystalline carbon.

The Si particles may be included in an amount of about 1 wt % to about 60 wt %, for example, about 3 wt % to about 60 wt %, based on the total weight of the Si—C composite.

The crystalline carbon may be, for example, graphite, and for example, natural graphite, artificial graphite, or a combination thereof.

An average particle diameter of the crystalline carbon may be about 5 μm to about 30 μm.

When the negative electrode active material includes the Si composite and the graphite together, the Si composite and the graphite may be included as a mixture, wherein the Si composite and the graphite may be included in a weight ratio of about 1:99 to about 50:50. For example, the Si composite and the graphite may be included in a weight ratio of about 3:97 to about 20:80 or about 5:95 to about 20:80.

In the negative electrode active material layer, the negative electrode active material may be included in an amount of about 95 wt % to about 99 wt % based on the total weight of the negative electrode active material layer.

In one or more embodiments of the present disclosure, the negative electrode active material layer includes a binder, and optionally a conductive material. In the negative electrode active material layer, a content of the binder may be about 1 wt % to about 5 wt % based on the total weight of the negative electrode active material layer. When it further includes the conductive material, the negative electrode active material layer may include about 90 wt % to about 98 wt % of the negative electrode active material, about 1 wt % to about 5 wt % of the binder, and about 1 wt % to about 5 wt % of the conductive material.

The binder improves binding properties of negative electrode active material particles with one another and with a negative electrode current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, phenolic resin, an epoxy resin, polyvinyl alcohol, and a combination thereof.

When the water-soluble binder is used as the negative electrode binder, a cellulose-based compound may be further used to provide viscosity as a thickener. The cellulose-based compound includes one or more of carboxymethyl cellulose, hydroxypropylmethyl cellulose, methyl cellulose, and/or alkali metal salts thereof. The alkali metal may be Na, K, and/or Li. Such a thickener may be included in an amount of about 0.1 to about 3 parts by weight based on 100 parts by weight of the negative electrode active material.

The conductive material is included to impart electrode conductivity. Any suitable electrically conductive material may be used as a conductive material unless it causes a chemical change. Examples of the conductive material include a carbon-based material such as natural graphite, artificial graphite, carbon black, acetylene black, ketjen black, a carbon fiber, and/or the like; a metal-based material of a metal powder and/or a metal fiber including copper, nickel, aluminum, silver, and/or the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

The electrolyte solution for a rechargeable lithium battery includes a non-aqueous organic solvent and a lithium salt.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, and/or aprotic solvent.

The carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may be methyl acetate, ethyl acetate, n-propyl acetate, t-butyl acetate, methyl propionate, ethyl propionate, propyl propionate, decanolide, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. The ketone-based solvent may be cyclohexanone, and/or the like. The alcohol-based solvent may be ethyl alcohol, isopropyl alcohol, etc., and the aprotic solvent may be selected from nitriles such as R¹—CN (where R¹ is a C2 to C20 linear, branched, or cyclic hydrocarbon group and may include a double bond, an aromatic ring, and/or an ether bond), amides such as dimethylformamide, dioxolanes such as 1,3-dioxolane, sulfolanes, and the like.

The non-aqueous organic solvent may be used alone or in a mixture. When the non-aqueous organic solvent is used in a mixture, the mixture ratio may be controlled in accordance with a desirable battery performance.

The carbonate-based solvent is prepared by mixing a cyclic carbonate and a chain (e.g., linear) carbonate. In this case, when the cyclic carbonate and the chain carbonate are mixed in a volume ratio of about 1:9 to about 9:1, performance of the electrolyte solution may be improved.

In one or more embodiments, the non-aqueous organic solvent may include the cyclic carbonate and the chain carbonate in a volume ratio of about 2:8 to about 5:5, and as an example, the cyclic carbonate and the chain carbonate may be included in a volume ratio of about 2:8 to about 4:6.

For example, the cyclic carbonate and the chain carbonate may be included in a volume ratio of about 2:8 to about 3:7.

The non-aqueous organic solvent may further include an aromatic hydrocarbon-based organic solvent, in addition to the carbonate-based solvent. In this case, the carbonate-based solvent and the aromatic hydrocarbon-based organic solvent may be mixed in a volume ratio of about 1:1 to about 30:1.

The aromatic hydrocarbon-based solvent may be an aromatic hydrocarbon-based compound represented by Chemical Formula 3:

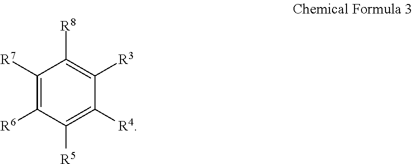

In Chemical Formula 3, R³ to R⁸ are the same as or different from each other and may be selected from hydrogen, a halogen, a C1 to C10 alkyl group, a C1 to C10 haloalkyl group, and a combination thereof.

Examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte solution for a rechargeable lithium battery may further include at least one other additive of vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithiumtetrafluoroborate (LiBF₄), lithium difluorophosphate (LiPO₂F₂), and/or 2-fluoro biphenyl (2-FBP).

By further including the aforementioned other additives, cycle-life may be further improved and/or gases generated from the positive electrode and the negative electrode may be effectively or suitably controlled during high-temperature storage.

The other additives may be included in an amount of about 0.2 to 20 parts by weight, for example, about 0.2 to 15 parts by weight, or about 0.2 to 10 parts by weight, based on 100 parts by weight of the electrolyte solution for a rechargeable lithium battery.

When the content of other additives is as described above, the increase in film resistance may be minimized or reduced, thereby contributing to the improvement of battery performance.

The lithium salt dissolved in the non-aqueous solvent supplies lithium ions in a battery, enables (e.g., facilitates) a basic operation of a rechargeable lithium battery, and improves transportation of the lithium ions between positive and negative electrodes. Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂) (CyF_{2y+1}SO₂) (wherein x and y are natural numbers, for example, an integer ranging from 1 to 20), LiCl, LiI, LiB(C₂O₄)₂ (lithium bis(oxalato) borate: LiBOB), LiDFOB (lithium difluoro(oxalato)borate), and Li[PF₂(C₂O₄)₂] (lithium difluoro(bisoxalato) phosphate). The lithium salt may be used in a concentration ranging from about 0.1 M to about 2.0 M. When the lithium salt is included at the above concentration range, an electrolyte may have excellent or improved performance and lithium ion mobility due to optimal or suitable electrolyte conductivity and/or viscosity.

The rechargeable lithium battery may further include a separator between the negative electrode and the positive electrode, depending on a type (or kind) of the battery. Such a separator may be a porous substrate and/or a composite porous substrate.

The porous substrate may be a substrate including pores, and lithium ions may move through the pores. The porous substrate may, for example, include polyethylene, polypropylene, polyvinylidene fluoride, and/or multi-layers thereof such as a polyethylene/polypropylene double-layered separator, a polyethylene/polypropylene/polyethylene triple-layered separator, and/or a polypropylene/polyethylene/polypropylene triple-layered separator.

The composite porous substrate may have a form including a porous substrate and a functional layer on the porous substrate. The functional layer may be, for example, at least one selected from a heat-resistant layer and an adhesive layer from the viewpoint of enabling additional function. For example, the heat-resistant layer may include a heat-resistant resin and, optionally, a filler.

In some embodiments, the adhesive layer may include an adhesive resin and, optionally, a filler.

The filler may be an organic filler and/or an inorganic filler.

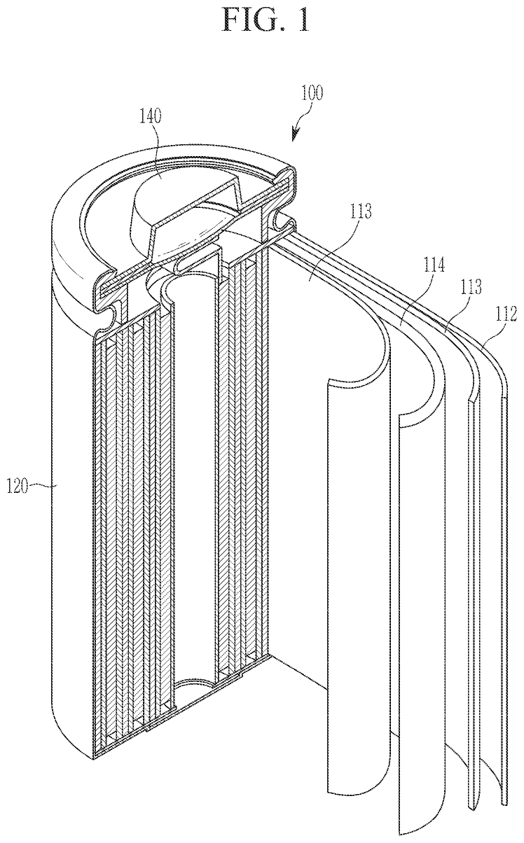

As an example of the rechargeable lithium battery, a cylindrical rechargeable lithium battery will be described. FIG. 1 schematically shows the structure of a rechargeable lithium battery according to one or more embodiments. Referring to FIG. 1, a rechargeable lithium battery 100 according to one or more embodiments includes a battery cell including a positive electrode 114, a negative electrode 112 facing to the positive electrode 114, and a separator 113 between the positive electrode 114 and the negative electrode 112, and an electrolyte solution impregnating the positive electrode 114, the negative electrode 112 and the separator 113, a battery container 120 housing the battery cell, and a sealing member 140 for sealing the container 120.

Hereinafter, examples of the present disclosure and comparative examples are described. These examples, however, are not in any sense to be interpreted as limiting the scope of the present disclosure.

### Manufacture of Rechargeable Lithium Battery Cell

### Comparative Example 1

LiNi_{0.88}Co_{0.07}Al_{0.05}O₂ as a positive electrode active material, polyvinylidene fluoride as a binder, and acetylene as a black conductive material were mixed in a weight ratio of 96:2:2 and then, dispersed in N-methyl pyrrolidone, to thereby prepare a positive electrode active material slurry.

The positive electrode active material slurry was coated on a 14 um-thick Al foil and then, dried at 110° C. and pressed, thus manufacturing a positive electrode.

Negative electrode active material slurry was prepared by mixing a mixture of artificial graphite and Si—C composite in a weight ratio of 93:7 as a negative electrode active material, a styrene-butadiene rubber as a binder, and carboxymethyl cellulose as a thickener in a weight ratio of 97:1:2, and dispersing the obtained mixture in distilled water.

The Si—C composite had a core including artificial graphite and silicon particles and coal pitch coated on the surface of the core.

The negative electrode active material slurry was coated on a 10 um-thick Cu foil and then, dried at 100° C. and pressed, thus manufacturing a negative electrode.

The positive and negative electrodes were assembled with a 25 um-thick polyethylene separator to prepare an electrode assembly, and then, an electrolyte solution was injected thereinto, thus manufacturing a rechargeable lithium battery cell.

The electrolyte solution had the following composition.

### Composition of Electrolyte Solution

### Salt: LiPF₆ 1.15 M

Solvent: ethylene carbonate: ethylmethyl carbonate: dimethyl carbonate (EC: EMC:DMC=volume ratio of 20:40:40)

Other additive: 1 part by weight of vinylene carbonate (VC) and 1 part by weight of LiPO₂F₂

(Herein, in the composition of the electrolyte solution, “parts by weight” means the relative weight of the additive based on 100 weight of the total (lithium salt+non-aqueous organic solvent) of the electrolyte solution excluding the additive.)

### Example 1

A rechargeable lithium battery cell was manufactured in substantially the same manner as in Comparative Example 1 except that 0.04 parts by weight of the additive represented by Chemical Formula a-1 were mixed based on 100 parts by weight of the positive electrode active material, the binder, and the conductive material and then, dispersed in N-methyl pyrrolidone.

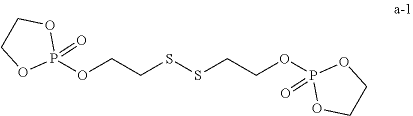 [SMILES: O=P1(OCCSSCCOP2(=O)OCCO2)OCCO1]

### Examples 2 to 4 and Comparative Examples 2 and 3

Each rechargeable lithium battery cell was manufactured in substantially the same manner as in Example 1 except that the content of the additive represented by Chemical Formula a-1 was changed as shown in Table 1.

### Comparative Example 4

A rechargeable lithium battery cell was manufactured in substantially the same manner as in Comparative Example 1 except that the additive represented by Chemical Formula a-1 in an amount shown in Table 1 was added to the electrolyte solution.

TABLE 1

| | Positive electrode | Electrolyte solution |
|---|---|---|
| | additive | additive |
| | Chemical Formula a-1 | Chemical Formula a-1 |
| | (parts by weight) | (parts by weight) |
| Comparative Example 1 | — | — |
| Comparative Example 2 | 0.0001 | — |
| Comparative Example 3 | 0.1 | — |
| Comparative Example 4 | — | 0.1 |
| Example 1 | 0.04 | — |
| Example 2 | 0.02 | — |
| Example 3 | 0.01 | — |
| Example 4 | 0.005 | — |

### Evaluation 1: Measurement of Amount of Gas Generated After High-Temperature Storage

The rechargeable lithium battery cells according to Examples 1 to 4, and Comparative Examples 1 to 3 were each manufactured as a 30 mAh cell belonging to 4.2 V Class, which was allowed to stand at 70° C. for 3 days, and an amount (ml) of generated gas was measured via an Archimedes' method, and the results are shown in Table 2.

### Evaluation 2: Evaluation of DC Resistance Increase Rate After High-Temperature Storage

The rechargeable lithium battery cells according to Examples 1 to 4 and Comparative Examples 1 to 3 were measured with respect to ΔV/ΔI (voltage change/current change) to obtain initial DC resistance (DC-IR), and after making a maximum energy state inside the cells into a full-charge state (SOC 100%) and storing them at 70° C. for 3 days in this state, remeasured with respect to DC resistance to calculate a DC resistance increase rate [{(DC-IR after 3 days)/(initial DC-IR)}*100], and the results are shown in Table 2.

TABLE 2

| | | | DC resistance | |
|---|---|---|---|---|
| | | | after high- | |
| | | Initial | temperature | DC |
| | Gas | DC | storage | resistance |
| | amount | resistance | @70° C./3D | increase |
| | (mL) | (Ω) | (Ω) | rate (%) |
| Comparative Example 1 | 0.174 | 2.630 | 3.800 | 144.487 |
| Comparative Example 2 | 0.173 | 2.629 | 3.802 | 144.618 |
| Comparative Example 3 | 0.005 | 3.300 | 3.359 | 101.788 |
| Example 1 | 0.047 | 2.630 | 2.710 | 130.042 |
| Example 2 | 0.084 | 2.610 | 2.789 | 106.858 |
| Example 3 | 0.129 | 2.620 | 2.830 | 108.015 |
| Example 4 | 0.145 | 2.625 | 2.900 | 110.476 |

Referring to Table 2, when the additive according to the present disclosure was included in the positive electrode composition, the amount of gas generated was significantly reduced, and the DC resistance increase rate after high-temperature storage relative to the initial DC resistance was relatively gradual.

Accordingly, storage characteristics at a high temperature of the rechargeable lithium battery cell were improved.

### Evaluation 3: Heat Flow Evaluation

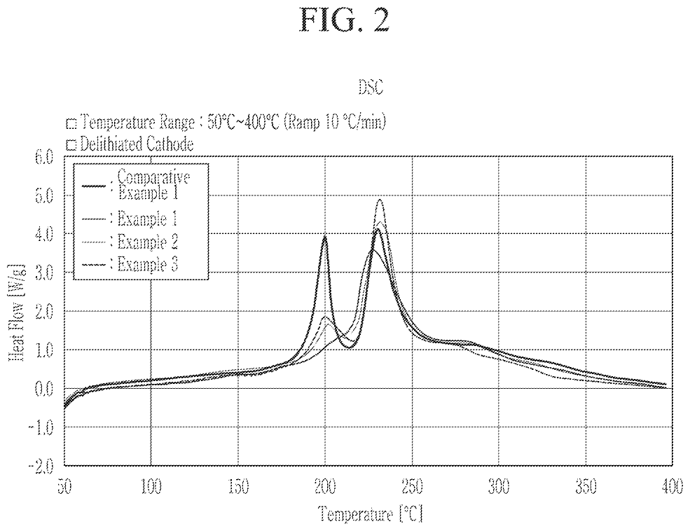

The positive electrodes according to Examples 1 to 3 and Comparative Example 1 were measured with respect to a heat flow according to a temperature through differential scanning calorimetry (DSC). A differential scanning calorimetry (SENSYS Evo, Setaram Instrumentation) was used, specifically, taking 15 mg of each electrode charged with 4.25 V (vs. Li/Li+), adding 20 mL of an electrolyte solution thereto, and then, heating the mixture at a rate of 10° C./min (ramp rate) to 400° C. The measured results are shown in FIG. 2.

FIG. 2 is a graph showing the amount of heat flow according to temperature measured by differential scanning calorimetry (DSC) for the positive electrodes according to Examples 1 to 3 and Comparative Example 1.

Referring to FIG. 2, the positive electrodes according to Examples 1 to 3 exhibited a decreased exothermic amount near 200° C. and/or 230° C., and a delayed peak temperature and thus, excellent or suitable high temperature stability, compared with the positive electrode according to Comparative Example 1.

### Evaluation Example 4: Component Analysis of Positive Electrode Film

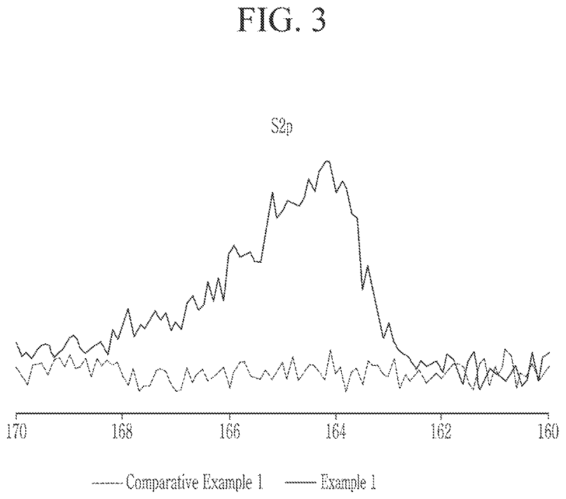

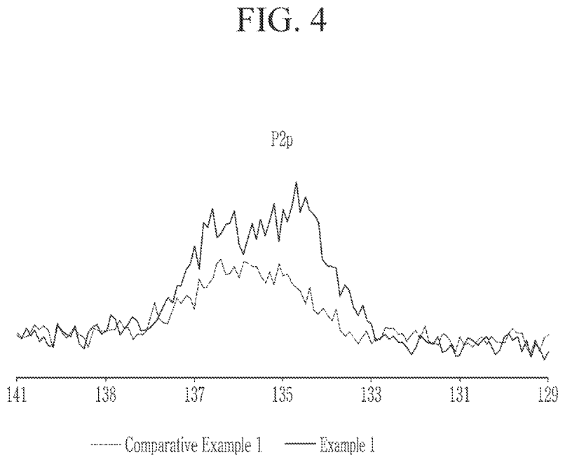

The rechargeable lithium battery cells according to Example 1 and Comparative Example 1 were analyzed through XPS (X-ray Photoelectron Spectroscopy) to analyze components of each positive electrode film, and the results are shown in FIGS. 3 and 4.

FIGS. 3 and 4 show XPS analysis results of the positive electrodes of the rechargeable lithium battery cells prepared according to Example 1 and Comparative Example 1.

Referring to FIGS. 3 and 4, Example 1 exhibited an S2p peak of binding energy around 163 eV to 165 eV, but Comparative Example 1 exhibited no S2p peak.

In addition, Example 1 exhibited a P2p peak of binding energy around 133 eV to 135 eV, but P2p peak of binding energy around 133 eV to 135 eV was almost not detected in Comparative Example 1 exhibited no (or significantly smaller) P2p peak.

Accordingly, it is believed that the rechargeable lithium battery cells according to the examples of the present disclosure turned out to have a film in which the additive included in the positive electrode compositions was coordinated on the surfaces of the respective positive electrodes.

### Evaluation Example 5: Evaluation of Electrolyte Solution Discoloration

After respectively allowing the electrolyte solutions of Comparative Examples 1 and 4 to stand at 45° C. for 3 days, a colorimeter (PFXi-195, Lovibond) was used to measure a discoloring degree in an APHA chromaticity standard measurement method, and the results are shown in Table 3.

### Measurement Method

1. After filling the DIW (De-Ionized Water) in the sample cell, the blank is measured.
2. After filling the electrolyte solution sample in the sample cell, the chromaticity is measured.
3. The result value on the equipment screen is checked.

TABLE 3

| | Initial | Chromaticity after high- |
|---|---|---|
| | color | temperature storage |
| | (APHA) | @45° C./3D (APHA) |
| Comparative Example 1 | 35 | 50 |
| Comparative Example 4 | 36 | 200 |

The closer to 0 based on 500 APHA of a platinum cobalt standard solution, the more transparent the solution, but the closer to 500 APHA, the more discolored the solution.

The standard electrolyte solution of Comparative Example 1 including no additive according to the present disclosure, and the electrolyte solution of Comparative Example 4 including the additive according to the present disclosure, exhibited similar initial chromaticity, but after respectively allowing the electrolyte solutions of Comparative Examples 1 and 4 to stand at 45° C. for 3 days, Comparative Example 1 exhibited 50 APHA, but Comparative Example 4 exhibited 200 APHA, which showed that when the additive according to the present disclosure was included in an electrolyte solution, a high discoloring degree was found.

### Evaluation 6: Evaluation of CV Characteristics

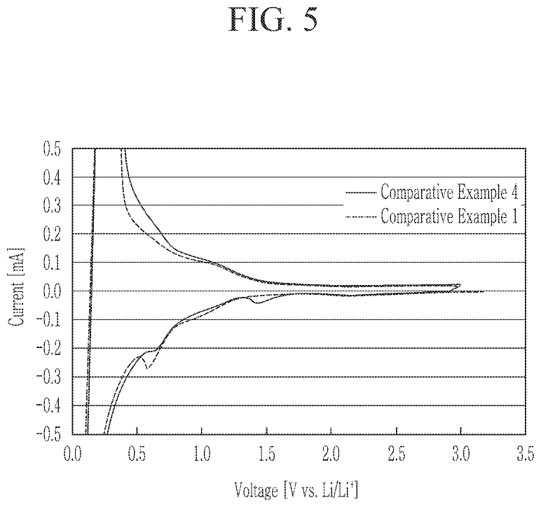

Electrochemical stability of the electrolyte solutions according to Comparative Example 1 and Comparative Example 4 was evaluated by measuring cyclic voltammetry (CV), and the results are shown in FIG. 5.

A negative electrode cyclic voltammetry (CV) was measured by using a triple electrode electrochemical cell using graphite as a working electrode and Li metals as a reference electrode and a counter electrode. Herein, scan was 3 cycles performed from 3 V to 0 V and from 0 V to 3 V at a rate of 0.1 mV/sec.

FIG. 5 is a graph showing the results of negative electrode cyclic voltammetry (CV) at room temperature of the electrolyte solutions according to Comparative Examples 1 and 4.

As shown in FIG. 5, the electrolyte solution of Comparative Example 4 exhibited a reduction decomposition peak near 1.5 V. Accordingly, it is believed that the additive according to the present disclosure would interact with the solvents in the electrolyte solution, and accordingly, the electrolyte solution of Comparative Example 4 (including the additive) may form an initial Solid Electrolyte Interface (SEI) film on the negative electrode, reducing an amount of a complex compound produced from the additive at the positive electrode and thus deteriorating the surface protection effect of the positive electrode.

While this disclosure has been described in connection with what is presently considered to be example embodiments, it is to be understood that the disclosure is not limited to the disclosed embodiments, but, on the contrary, is intended to cover various modifications and equivalent arrangements included within the spirit and scope of the appended claims and their equivalents.

### DESCRIPTION OF SYMBOLS

100: rechargeable lithium battery
112: negative electrode
113: separator
114: positive electrode
120: battery case
140: sealing member

What is claimed is:

1. A positive electrode, comprising
a positive electrode active material,
a binder,
a conductive material, and
an additive represented by Chemical Formula 1 or Chemical Formula 2: 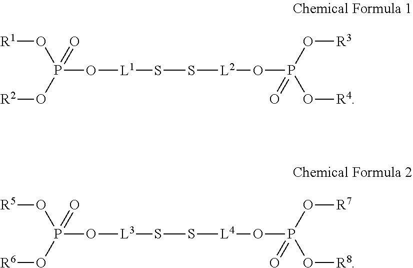
wherein, in Chemical Formula 1 and Chemical Formula 2,
R¹ to R⁸ are each independently a substituted or unsubstituted C1 to C10 alkyl group, a substituted or unsubstituted C2 to C10 alkenyl group, a substituted or unsubstituted C3 to C10 cycloalkyl group, a substituted or unsubstituted C3 to C10 cycloalkenyl group, a substituted or unsubstituted C2 to C10 alkynyl group, a substituted or unsubstituted C3 to C10 cycloalkynyl group, or a substituted or unsubstituted C6 to C20 aryl group,
R¹ to R⁸ are each independently present, or
at least one pair selected from R¹ and R²; R³ and R⁴; R⁵ and R⁶; and R⁷ and R⁸ is linked to each other to form a substituted or unsubstituted C2 to C30 monocyclic or C2 to C50 polycyclic aliphatic heterocycle, or a substituted or unsubstituted C2 to C30 monocyclic or C2 to C50 polycyclic aromatic heterocycle, and
L¹ to L⁴ are each independently a substituted or unsubstituted C1 to C20 alkylene group.

2. The positive electrode of claim 1, wherein
Chemical Formula 1 is represented by Chemical Formula 1A or Chemical Formula 1B: 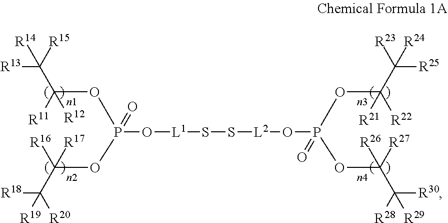
wherein, in Chemical Formula 1A,
R¹¹ to R³⁰ are each independently hydrogen, a halogen, or a substituted or unsubstituted C1 to C10 alkyl group,
n1 to n4 are each independently an integer of 0 to 4, and
L¹ and L² are each independently a substituted or unsubstituted C1 to C20 alkylene group; 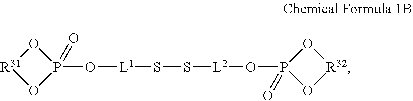
and
wherein, in Chemical Formula 1B,
R³¹ and R³² are each independently a substituted or unsubstituted C2 to C10 alkylene group, and
L¹ and L² are each independently a substituted or unsubstituted C1 to C20 alkylene group.

3. The positive electrode of claim 2, wherein
Chemical Formula 1B is represented by Chemical Formula 1B-I or Chemical Formula 1B-II: 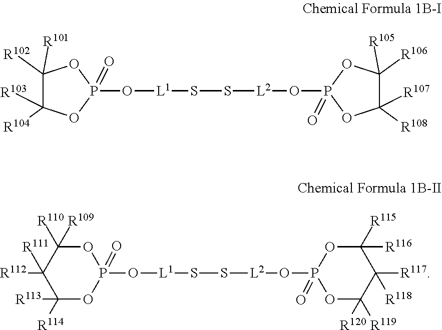
and
wherein, in Chemical Formula 1B-I and Chemical Formula 1B-II,
R¹⁰¹ to R¹²⁰ are each independently hydrogen, a halogen, or a substituted or unsubstituted C1 to C10 alkyl group, and
L¹ and L² are each independently a substituted or unsubstituted C1 to C20 alkylene group.

4. The positive electrode of claim 1, wherein
Chemical Formula 2 is represented by Chemical Formula 2A or Chemical Formula 2B: 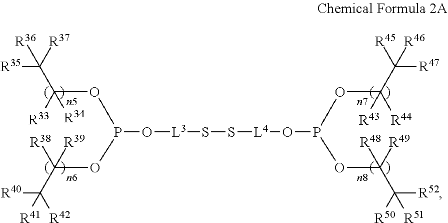
wherein, in Chemical Formula 2A,
R³³ to R⁵² are each independently hydrogen, a halogen, or a substituted or unsubstituted C1 to C10 alkyl group,
n5 to n8 are each independently an integer of 0 to 4, and
L³ and L⁴ are each independently a substituted or unsubstituted C1 to C20 alkylene group; 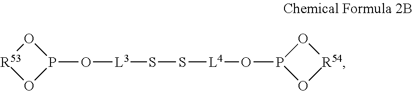
and
wherein, in Chemical Formula 2B,
R⁵³ and R⁵⁴ are each independently a substituted or unsubstituted C2 to C10 alkylene group, and
L³ and L⁴ are each independently a substituted or unsubstituted C1 to C20 alkylene group.

5. The positive electrode of claim 4, wherein
Chemical Formula 2B is represented by Chemical Formula 2B-I or Chemical Formula 2B-II: 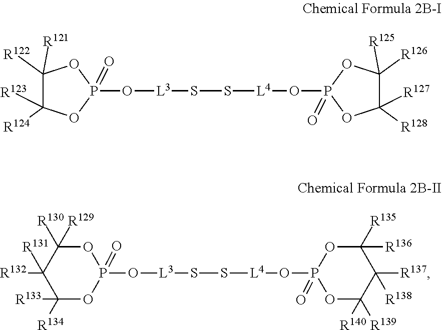
and
wherein, in Chemical Formula 2B-I and Chemical Formula 2B-II,
R¹²¹ to R¹⁴⁰ are each independently hydrogen, a halogen, or a substituted or unsubstituted C1 to C10 alkyl group, and
L³ and L⁴ are each independently a substituted or unsubstituted C1 to C20 alkylene group.

6. The positive electrode of claim 1, wherein
Chemical Formula 1 is represented by Chemical Formula 1B-I-1 or Chemical Formula 2B-I-1: 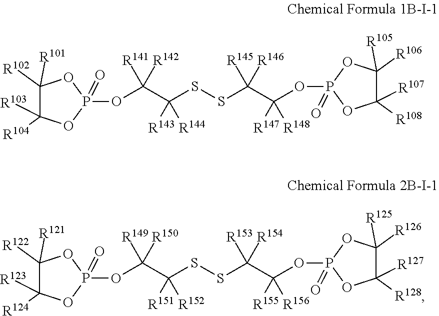
and
wherein, in Chemical Formula 1B-I-1 and Chemical Formula 2B-I-1,
R¹⁰¹ to R¹⁰⁸, R¹²¹ to R¹²⁸, and R¹⁴¹ to R¹⁵⁶ are each independently hydrogen, a halogen, or a substituted or unsubstituted C1 to C10 alkyl group.

7. The positive electrode of claim 1, wherein
the additive is in an amount of about 0.001 to 0.05 parts by weight based on 100 parts by weight of the positive electrode active material, the binder, and the conductive material.

8. The positive electrode of claim 1, wherein
the additive is in an amount of about 0.005 to 0.05 parts by weight based on 100 parts by weight of the positive electrode active material, the binder, and the conductive material.

9. The positive electrode of claim 1, wherein
the positive electrode active material is represented by Chemical Formula 4:
LiₓM¹_{y}M²_{z}M³_{1-y-z}O_{2±a}X_{b}, and
wherein, in Chemical Formula 4,
0.5≤x≤1.8, 0≤a≤0.1, 0≤b≤0.1, 0<y≤1, 0≤z≤1, 0<y+z≤1,
M¹, M², and M³ are each independently one or more elements selected from Ni, Co, Mn, Al, B, Ba, Ca, Ce, Cr, Fe, Mo, Nb, Si, Sr, Mg, Ti, V, W, Zr, La, and a combination thereof, and
X is one or more selected from F, S, P, and Cl.

10. The positive electrode of claim 9, wherein
wherein, in Chemical Formula 4,
0.8≤y≤1, 0≤z≤0.2, and M¹ is Ni.

11. A rechargeable lithium battery, comprising
the positive electrode of claim 1;
a negative electrode comprising a negative electrode active material; and
an electrolyte solution for the rechargeable lithium battery.

12. The rechargeable lithium battery of claim 11, wherein
a positive electrode film is further on a surface of the positive electrode, and
the positive electrode film is formed by coordinating the additive represented by Chemical Formula 1 or Chemical Formula 2 to the positive electrode active material.

13. The rechargeable lithium battery of claim 11, wherein
the negative electrode active material comprises at least one selected from graphite and Si composite.

14. The rechargeable lithium battery of claim 13, wherein
the Si composite comprises a core comprising Si-based particles and an amorphous carbon coating layer.

15. The rechargeable lithium battery of claim 14, wherein
the Si-based particles comprise at least one selected from Si particles, a Si—C composite, SiOₓ (0<x≤2), and a Si alloy.
